(19) United States
(12) Patent Application Publication
(10) Pub. No.: US 2008/0245480 A1
(43) Pub. Date: Oct. 9, 2008

(54) LAMINATOR MENU SYSTEM

(75) Inventors: Colin Knight, Winnetka, IL (US); Christophe de Schaetzen, Bonlez (BE)

Correspondence Address: MICHAEL BEST & FRIEDRICH LLP, 100 EAST WISCONSIN AVENUE, SUITE 3300, MILWAUKEE, WI, 53202, US

(73) Assignee: ACCO BRANDS USA LLC, Lincolnshire, IL (US)

(21) Appl. No.: 11/969,696

(22) Filed: Jan. 4, 2008

Related U.S. Application Data
(60) Provisional application No. 60/883,665, filed on Jan. 5, 2007.

(51) Int. Cl. B32B 37/00

(52) U.S. Cl. 156/378

(57) ABSTRACT

A method of operating a laminator includes inputting a variable that corresponds to a set point temperature of a roller of the laminator, determining an actual temperature of the roller of the laminator, and estimating a time until the actual temperature of the roller approximately equals the set point temperature of the roller.

### CROSS-REFERENCE TO RELATED APPLICATIONS

This application claims priority to U.S. Provisional Patent Application No. 60/883,665, filed Jan. 5, 2007, the entire contents of which are hereby incorporated by reference.

### BACKGROUND

The present invention relates to laminators and more particularly to menu systems for operating laminators.

Laminators typically include rollers that can be heated in order to apply heat and pressure to a film that surrounds a media being laminated by the laminator. Often, the operating temperature of the rollers (i.e., a temperature set point) can be adjusted by the user based on a thickness of a film used to laminate a media. Typically, the user utilizes a printed chart or table to determine the temperature set point based on the thickness of the film and whether a carrier is utilized with the film and media. Then, the user inputs the temperature set point and/or the speed set point, and when the rollers reach the temperature set point, the user inserts the film and media into the laminator.

### SUMMARY

In one embodiment, the present invention provides a method of operating a laminator. The method includes inputting a variable that corresponds to a set point temperature of a roller of the laminator, determining an actual temperature of the roller of the laminator, and estimating a time until the actual temperature of the roller approximately equals the set point temperature of the roller.

In another embodiment, the invention provides a method of operating a laminator. The method includes inputting a set point temperature of a roller of the laminator, determining an actual temperature of the roller, estimating a time until the actual temperature of the roller approximately equals the set point temperature of the roller using a look-up table stored by a microprocessor of the laminator, and displaying the time.

In yet another embodiment, the invention provides a laminator including a housing, a roller located within the housing, and an input device operable to receive an input from a user. The laminator also includes a processor operable to determine a set point temperature based on the input received by the input device and a temperature sensing element operable to determine an actual temperature of the roller. The processor is operable to estimate a time until the actual temperature of the roller approximately equals the set point temperature.

In still another embodiment, the invention provides a method of operating a laminator including a display and a roller. The method includes displaying a plurality of indicia on the display of the laminator, selecting at least one of the plurality of indicia, and determining a set point temperature of the roller of the laminator based on the at least one of the plurality of indicia selected

### BRIEF DESCRIPTION OF THE DRAWINGS

FIG. 1 illustrates a laminator embodying the present invention.

FIG. 2 illustrates a display and user controls of the laminator of FIG. 1.

FIGS. 3a-3m schematically illustrate the display and user controls of the laminator of FIG. 1 during a method of operating of the laminator.

FIGS. 4a-4h illustrate an alternative construction of the display and user controls and an alternative method of operating the laminator of FIG. 1.

FIGS. 5a-5i illustrate another alternative construction of the display and user controls and another alternative method of operating the laminator of FIG. 1.

FIG. 6 illustrates an alternative construction of the laminator of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

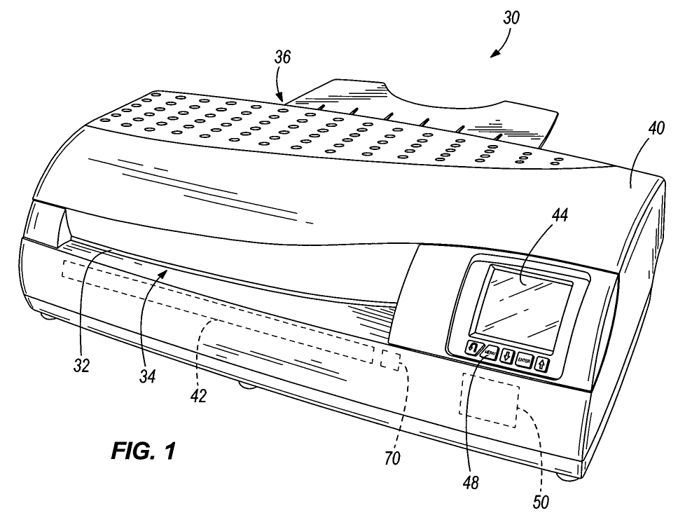

FIG. 1 illustrates a laminator 30. The laminator 30 includes a slot 32 that defines an input end 34 of the laminator 30 and an output end 36 of the laminator 30. The laminator 30 further includes a housing 40. As would be understood by one of skill in the art, the housing 40 houses rollers 42 that can be heated and are operable to laminate a media, such as paper, photo paper, cards, poster boards, brochures, and the like with a film.

In the illustrated construction, the laminator 30 is a pouch laminator. Therefore, as would be understood by one of skill in the art, the media to be laminated is placed in a pouch formed from the film that is used to laminate the media. The pouch and media are then inserted into the slot 32 at the input end 34 of the laminator 30 for lamination. In one method of operating the laminator 30, the pouch and the media can be placed into a carrier, which, as would be understood by one of skill in the art, prevents direct contact between the heated rollers 42 of the laminator 30 and the pouch.

The laminator 30 further includes a screen or operating display 44 and a user input device or user controls 48. The user operating display 44 and the user controls 48 are utilized in combination with a microprocessor 50 of the laminator 30 to control or operate the laminator 30. The microprocessor 50 can be any suitable microprocessor, such as an EEPROM microprocessor and the like.

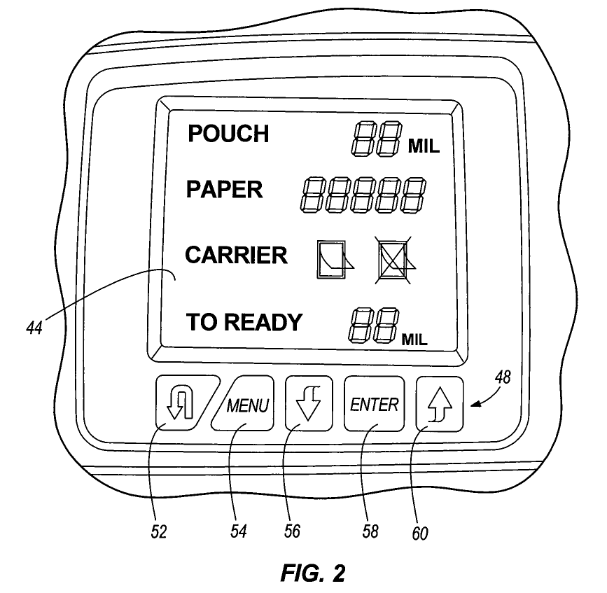

Referring to FIG. 2, the illustrated user controls 48 include buttons 52, 54, 56, 58, and 60. The scroll down button 56 and the scroll up button 60 are utilized by the user to scroll down and up, respectively, between choices listed on the display 44 to highlight the desired selection. The enter button 58 is utilized to select the choice on the display 44 that is highlighted and the menu button 54 is utilized to return to a main or starting menu. The reverse button 52 is utilized to return to a previous display.

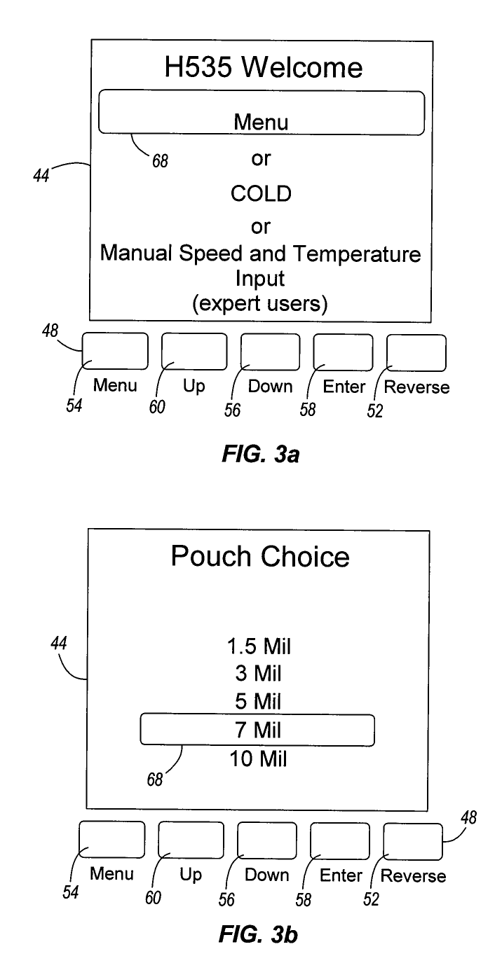

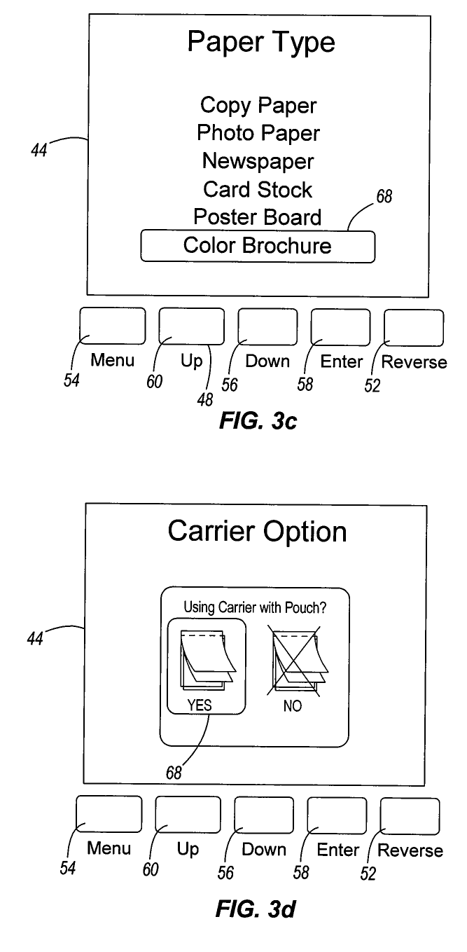

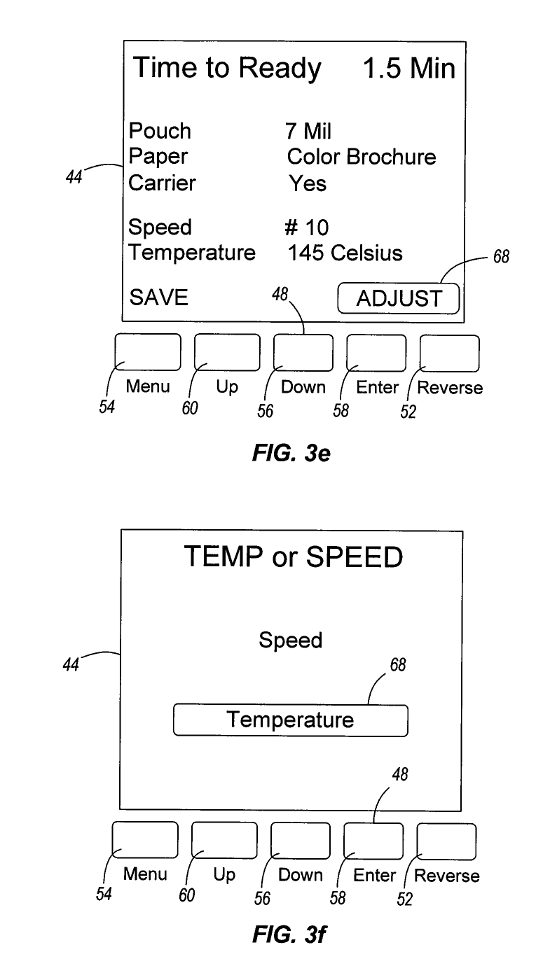

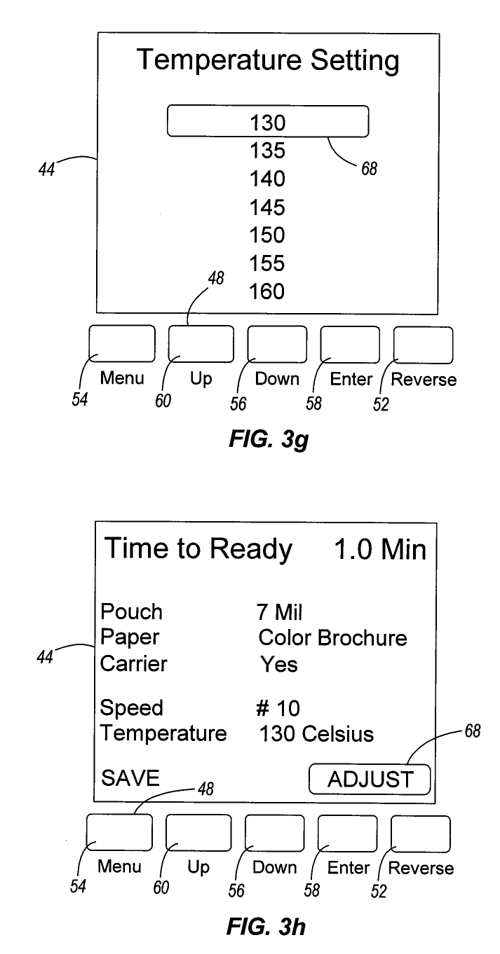

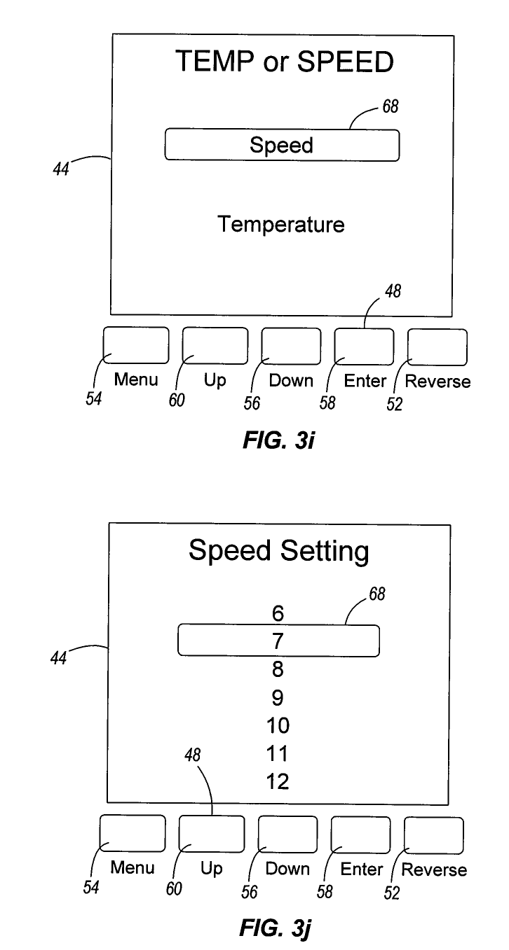

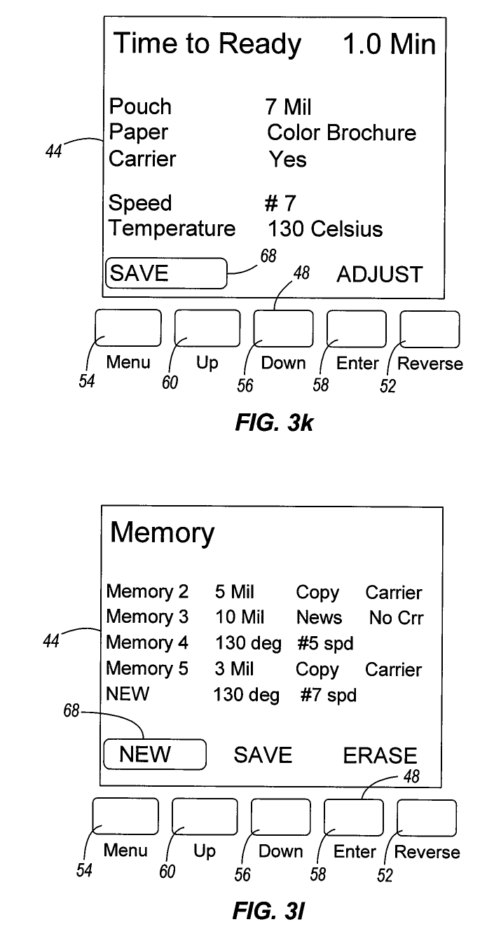

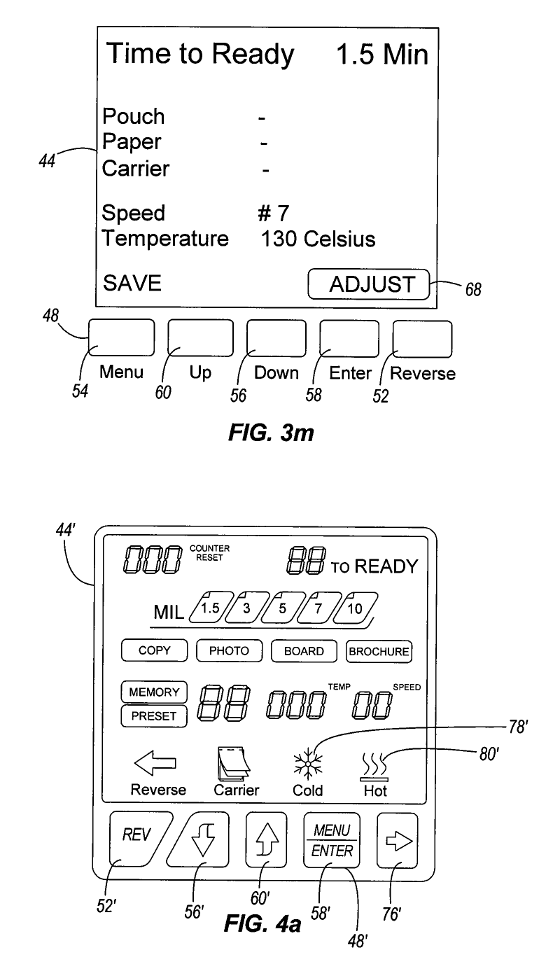

FIGS. 3a-3m illustrate one method of operating the laminator 30 that can be programmed to the microprocessor 50 of the laminator 30. FIGS. 3a-3m are schematic illustrations of the display 44 and the user controls 48 of the laminator 30 of FIGS. 1. There is some variation between the layout of the user controls and the display of FIGS. 1-2 and FIGS. 3a-3m. FIGS. 1-2 and FIGS. 3a-3m illustrate two possible layouts or constructions of the display and user controls and in other constructions the display and user controls can have any suitable layout or configuration.

In the method of operating the laminator 30 illustrated in FIG. 3a-3m, discussed below, the user can input variables, such as the thickness of the pouch, the type of media being laminated, and whether a carrier is utilized (collectively “user inputs”). Based on the user inputs, the microprocessor determines an appropriate operating temperature (i.e., temperature set point), approximate time until the laminator reaches the appropriate operating temperature (i.e., time to ready), and the appropriate operating speed (i.e., speed set point). As will be discussed below, the method of operating the laminator 30 also allows the user to customize the operation of the laminator 30 by selecting the temperature set point and the speed set point.

FIG. 3a illustrates an initial screen or start screen that appears on the display screen 44 when the user begins to use the laminator 30 (FIG. 1), such as by turning ‘on’ the laminator 30 (i.e., supplying power to the laminator 30). The user selects from the illustrated choices, ‘Menu,’ ‘Cold,’ or ‘Manual Speed and Temperature Input’ by using the ‘up’ button 60 or the ‘down’ button 56 to highlight, represented by a box 68, the desired choice. After highlighting the desired choice, the user presses the ‘enter’ button 58. If the user selects the ‘Menu’ option from the start screen illustrated in FIG. 3a, a ‘Pouch Choice’ screen appears on the display 44 (FIG. 3b). Referring to FIG. 3b, the user then selects the thickness of the pouch that will be utilized. In the illustrated construction, the laminator 30 is operable to laminate pouches with film thicknesses from about 1.5 mils (i.e., 0.0015 inches) to about 10 mils (i.e., 0.010 inches), and the user is able to choose from pouch thicknesses of 1.5 mil, 3 mil, 5 mil, 7 mil, and 10 mil. Of course, in other constructions, the laminator can be configured to laminate pouches with any suitable range of thicknesses, and the ‘Pouch Choice’ display screen can include any suitable range of thicknesses at any suitable increment.

Referring to FIG. 3c, after the user selects the pouch thickness, a ‘Paper Type’ screen is displayed and the user selects the paper type or media that will be laminated. In the illustrated construction, the user can select from the types of paper or media illustrated in FIG. 3c. In other constructions, the ‘Paper Type’ menu can include any suitable media that can be laminated by the laminator 30.

Referring to FIG. 3d, after the user selects the paper type, a ‘Carrier Option’ screen is displayed and the user selects whether a carrier will be utilized during lamination of the media.

While the illustrated method of operation includes the user selecting pouch thickness, then paper type, then whether a carrier is utilized, in other constructions, these questions can be asked in any order. In yet other constructions, one or more of these user inputs or questions can be omitted. For example, a carrier may always be utilized with some constructions of laminators, and in such constructions, the ‘Carrier Option’ screen may be omitted because the microprocessor 50 is already programmed to account for the carrier.

Referring to FIG. 3e, after the user enters the pouch thickness, the paper type, and whether a carrier is utilized, the microprocessor 50 determines the appropriate temperature set point (i.e., operating temperature of the rollers of the laminator 30) and speed set point (i.e., rotational speed of the rollers). For example, as illustrated in FIG. 3e for one construction, if the user selects a pouch thickness of 7 mil, a paper type of color brochure, and that a carrier is utilized, the microprocessor 50 will utilize a programmed set point look-up table to determine that the appropriate temperature set point of the rollers 42 of the laminator 30 is approximately 145° C. and the appropriate speed set point is speed setting number 10, which corresponds to a rotational speed of the rollers 42 of the laminator 30.

Accordingly, the microprocessor 50 of the laminator 30 utilizes the user inputs to determine the appropriate temperature set point and speed set point. Thus, the user does not have to know the appropriate temperature or speed set points and the user does not have to calculate or look-up the temperature or speed set points using printed tables, charts, etc. The automatic determination of the temperature and speed set points based on the user inputs can be particularly advantageous for novice or inexperienced users of the laminator 30 who do not know the appropriate temperature and speed set points.

Referring to FIGS. 1 and 3e, the laminator 30 further includes a temperature sensing element 70, such as a thermocouple, that senses an actual temperature of the laminator rollers 42, which may include sensing the temperature of the area around the rollers 42 or the lamination area. The microprocessor 50 is operable with the temperature sensing element 70 to determine the actual temperature of the rollers 42. Based on the temperature set point and the actual temperature of the rollers 42, the microprocessor 50 of the laminator 30 utilizes a time to ready look-up table to determine a ‘time to ready’ or an approximate time until the rollers 42 of the laminator 30 reach the temperature set point. For example, if the actual temperature of the rollers 42 is 100° C. and the temperature set point is 145° C., the microprocessor 50 utilizes the look-up table to determine that for an actual temperature of 100° C. and a set point of 145° C., the time to ready is approximately 1.5 minutes. The microprocessor can repeat the ‘time to ready’ determination or look-up at any appropriate interval, such as at a time interval (i.e., every 5 seconds) or at a temperature interval (i.e., every change in 5 degrees of the rollers) to update the time to ready that is displayed. Such an update can account for variations in ambient temperature, operating conditions, etc. that may change the heating rate of the rollers from the approximate heating rate of the rollers in the look-up table. Alternatively, the microprocessor 50 need not repeat the look-up, but could make only a single determination of ‘time to ready.’ Such constructions may utilize a countdown timer to count down the time to ready.

The time to ready look-up table can be created using any suitable method. For example, the look-up table can be created using experimental data based on heating and cooling rates of the rollers 42, calculations utilizing the specific heat of the rollers 42, and the like. In one construction, the look-up table can be automatically updated based on recent actual heating and cooling rates of the rollers 42 of the laminator 30.

Also, the time to ready look-up table can be utilized when the rollers 42 are either heated or cooled to reach the set point temperature. For example, the actual temperature of the rollers 42 may be above the set point temperature, especially if the laminator 30 was utilized for laminating at a prior set point temperature that was greater than the new set point temperature. Therefore, the ‘time to ready’ can be determined based on the estimated time it will take for the ambient air to cool the rollers 42 to a lower set point. This data can also be provided in the look-up table.

The ‘time to ready’ display provides the user with an estimated time until the laminator is ready for operation. Thus, the user knows about how long it will be until the laminator is properly heated and the user can perform other tasks while the laminator is heating. The ‘time to ready’ feature can be particularly convenient for novice or inexperienced users of the laminator who are unaware of the heating time of the laminator.

Referring to FIG. 3e, after the user enters the user inputs, the user can manually adjust the speed and temperature set points if desired. The user may desire to manually input the speed and temperature set points to improve or customize the results provided by the automatically calculated set points, especially if the user is an experienced user of the laminator. As illustrated in FIG. 3e, if the user highlights and selects ‘Adjust’ a temperature or speed selection screen will be appear on the display 44 (FIG. 3f). Then, the user can highlight and select either ‘Temperature’ or ‘Speed.’ Referring to FIGS. 3f and 3g, if the user selects ‘Temperature’ a ‘Temperature Setting’ screen will appear on the display 44 (FIG. 3g), and the user can select from a list of temperature set points. While FIG. 3g illustrates temperature set points from 130° C. to 160° C. at 5° C. intervals, in other constructions any suitable range of temperatures can be listed at any suitable interval.

Referring to FIG. 3h, if the user updates the temperature set point (e.g., to 130° C. from 145° C.), the display 44 is updated accordingly and the ‘time to ready’ also updates accordingly (e.g., to 1.0 minutes from 1.5 minutes) using the time to ready look-up table as discussed above.

Referring to FIG. 3i, the user may also manually adjust the set point speed of the rollers. If the user selects ‘Speed’ from the temperature or speed selection screen, as illustrated in FIG. 3i, a ‘Speed Setting’ screen will appear on the display 44 as illustrated in FIG. 3j. Using the ‘Speed Setting’ screen, the user selects from listed speed set points that correspond to a rotational speed of the rollers 42 such that the user can increase or decrease the speed at which the media, pouch, and carrier (if applicable) are fed through the laminator 30. FIG. 3j illustrates just one possible list of speed set points, and in other constructions, there can be more or less speed set points at any suitable interval.

Referring to FIG. 3k, if the user manually selects an alternative speed set point the display 44 is updated to list the revised speed set point (e.g., from #10 to #7). As illustrated in FIG. 3k, the user can highlight and select ‘Save’ to save the entered speed and temperature set points. Referring to FIG. 31, the speed and temperature set points can be saved to provide a list of operating modes or preset operating modes. For example, as illustrated on the display 44 of FIG. 31, the speed set point of #7 and the temperature set point of 130° C. can be saved by the microprocessor 50 so the user can access the preset operating mode without manually entering the speed and temperature set points as described above. Rather, at the start screen (FIG. 3a), the user can select the ‘Menu’ option. If the user selects the ‘Menu’ option, the memory screen (FIG. 31) will appear on the display 44. Then, the user can select from one of the preset operating modes listed on the display 44. As illustrated, in FIG. 31, the user can add new preset operating modes using the ‘New’ and ‘Save’ selections or the user can delete preset operating modes using the ‘Erase’ selection. As illustrated in FIG. 31, the preset operating modes can include temperature and speed set points or preset operating modes that include the inputs of pouch thickness, paper type, and whether a carrier is utilized.

After the user selects the appropriate preset operating mode, an output display screen, such as the screen illustrated in FIG. 3k, will appear on the display screen 44. The output screen includes the ‘time to ready’ or approximate time until the rollers 42 reach the temperature set point. As discussed above, the ‘time to ready’ is determined using the microprocessor 50 of the laminator 30 and the look-up table based on the temperature set point and the actual temperature of the rollers 42 and the ‘time to ready’ is updated periodically so that the user knows the approximate time until the laminator 30 is ready for use.

Referring, to FIG. 3a, the user can also manually input the speed and temperature set points without inputting the pouch thickness, paper type, and whether a carrier is utilized. If the user selects ‘Manual Speed and Temperature Input’ from the start screen (FIG. 3a) the temperature setting screen (FIG. 3g) is displayed and the user selects the desired temperature set point. After the user inputs the desired temperature set point, the speed setting screen (FIG. 3j) is displayed and the user selects the desired speed set point. Referring to FIG. 3m, after the speed and temperature set points are entered, the output screen appears on the display 44 (FIG. 3m). As discussed above, the microprocessor 50 utilizes the look-up table to determine the ‘time to ready’ or approximate time until the rollers 42 reach the temperature set point.

The microprocessor 50 of the laminator 30 periodically determines the ‘time to ready,’ as discussed above, until the actual temperature of the rollers 42 is approximately equal to the temperature set point. When the actual temperature of the rollers 42 reach the set point temperature, the display 44 can include indicia, such as ‘ready’ or ‘ready to laminate’ to indicate to the user that the rollers 42 have reached the set point temperature. In other embodiments, a separate light may be used to indicate the laminator 30 is ready to laminate. Referring to FIG. 1, when the rollers 42 of the laminator 30 are at the set point temperature, the user can insert the pouch, media, and carrier (if applicable) into the slot 32 at the input end 34 of the laminator 30 and the rollers 42 will laminate the media using the film of the pouch and discharge the laminated media at the output end 36 of the laminator 30.

Referring to FIGS. 1 and 3a, if the user selects the ‘Cold’ option from the start screen, the laminator 30 is configured for cold lamination. As would be understood by one of skill in the art, cold lamination includes laminating the media without heating the rollers 42. Therefore, when the user selects cold lamination, the laminator 30 is set to a desired speed, either automatically or by the user selecting the desired speed, and then the laminator 30 is ready to laminate the media.

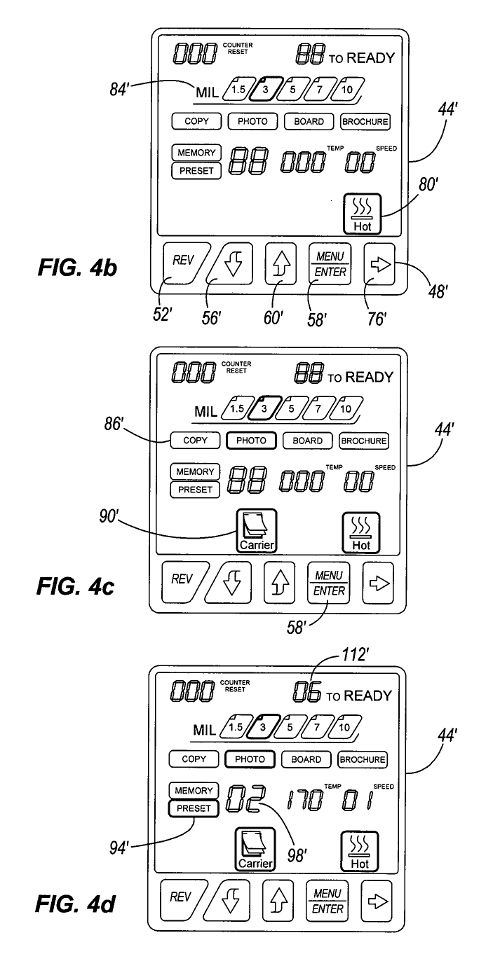

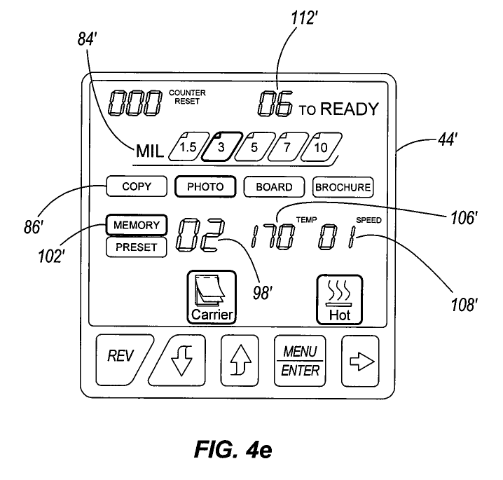

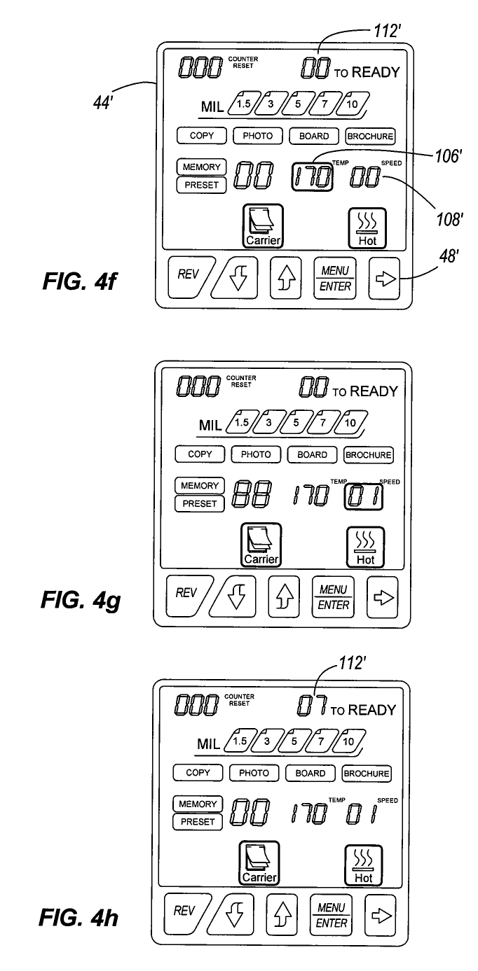

FIGS. 4a-4h illustrate an alternative construction of the display 44 and the user controls 48 of the laminator 30 of FIGS. 1-3m. The display 44′ and the user controls 48′ illustrated in FIGS. 4a-4h and the method of operation are substantially the same as the display 44, the controls 48, and the method of operation discussed above with regard to the laminator 30 of FIGS. 1-3m and therefore like components have been given like reference numbers plus a prime symbol and only the general differences will be discussed in detail below.

FIG. 4a illustrates the display 44′ with all of the indicators of the display lighted or in an ‘on’ configuration. The user controls 48′ further include a horizontal scroll arrow button 76′ that allows the user to scroll in a horizontal direction to select choices that appear on the display 44′. The display 44′ further includes ‘cold’ indicia 78′ and ‘hot’ indicia 80′ to indicate a relative temperature of the rollers.

Referring to FIG. 4b, the user selects the thickness of the pouch from a thickness listing 84′ and then, as illustrated in FIG. 4c, the media or paper type from a paper listing 86′. Referring to FIG. 4c, in the illustrated construction, the use of a carrier is set as the default and the user can scroll to a carrier indicia 90′ and push the enter button 58′ to indicate that a carrier is not being utilized, and then the carrier indicia 90′ would be turned ‘off’ or not highlighted.

Referring to FIG. 4d, the user can save the inputs by highlighting and selecting (i.e, pressing the enter button 58′) a preset indicia 94′. By saving the inputs, the preset operating mode is assigned a corresponding preset number 98′. Therefore, as illustrated in FIG. 4e, rather than re-entering the inputs, the user can scroll to the memory indicia 102′, which allows the user to scroll through a list of the preset numbers 98′ that correspond to the preset operating modes. As illustrated in FIG. 4e, temperature and speed set points that correspond to the preset number 98′ are indicated by a temperature set point display 106′ and a speed set point display 108′, respectively, and the corresponding thickness and paper type are indicated by the thickness and paper listings 84′ and 86′, respectively.

Referring to FIG. 4f, alternatively, the user can highlight and select the temperature set point display 106′ to manually enter the temperature set point and the user can highlight and select the speed set point display 108′ to manually enter the speed set point using the user controls 48′.

Referring to FIGS. 4d, 4e, and 4h, whether the inputs are entered manually (FIGS. 4f-4h), using the preset operating modes (FIG. 4e), or selecting the inputs (FIGS. 4b-4d), a time to ready display 112′ displays the approximate time until the actual temperature of the rollers reaches the set point temperature as discussed above.

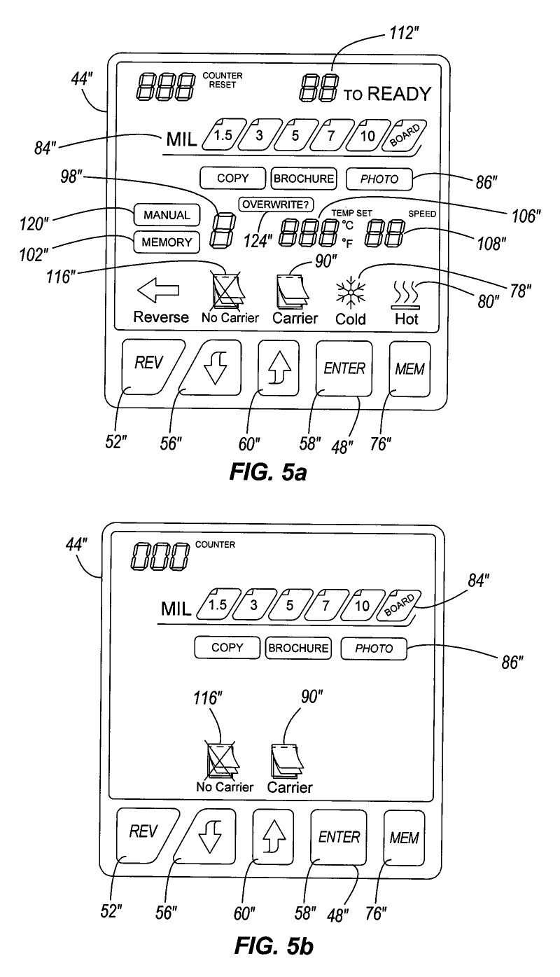

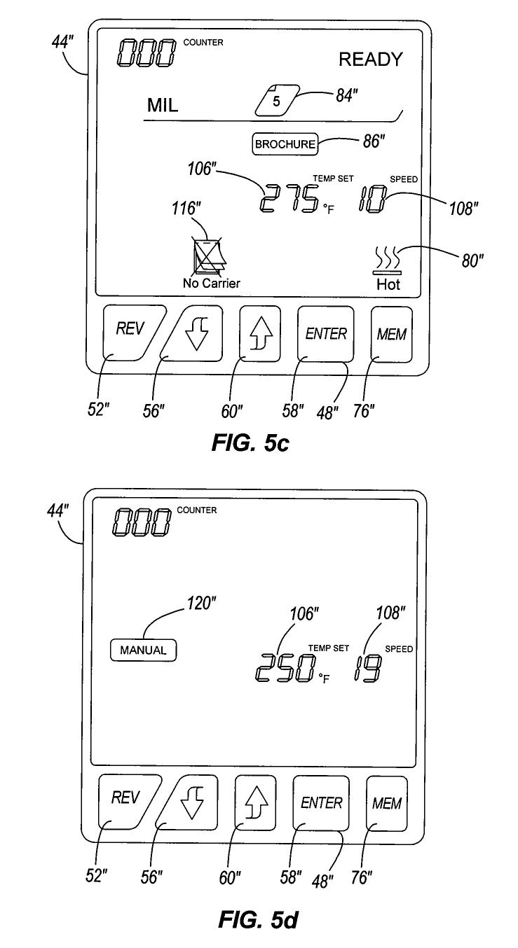

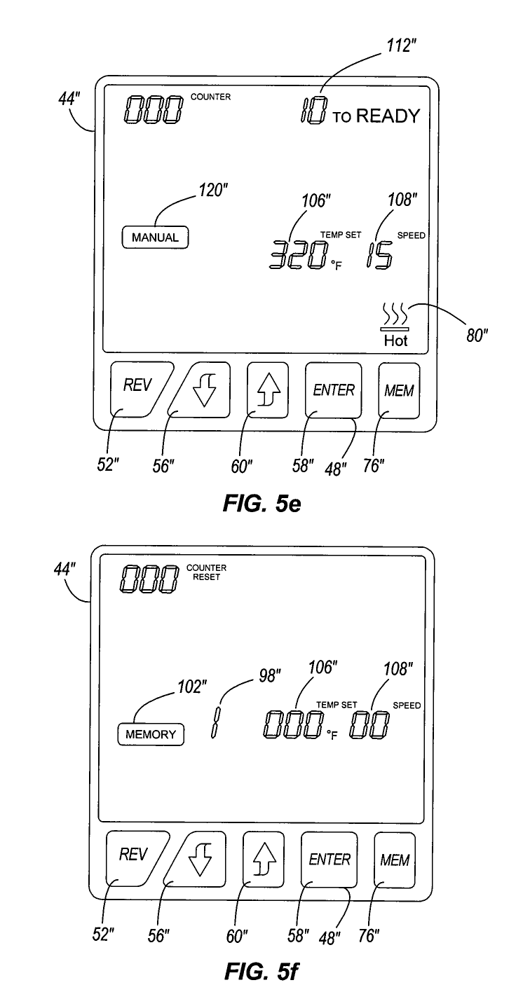

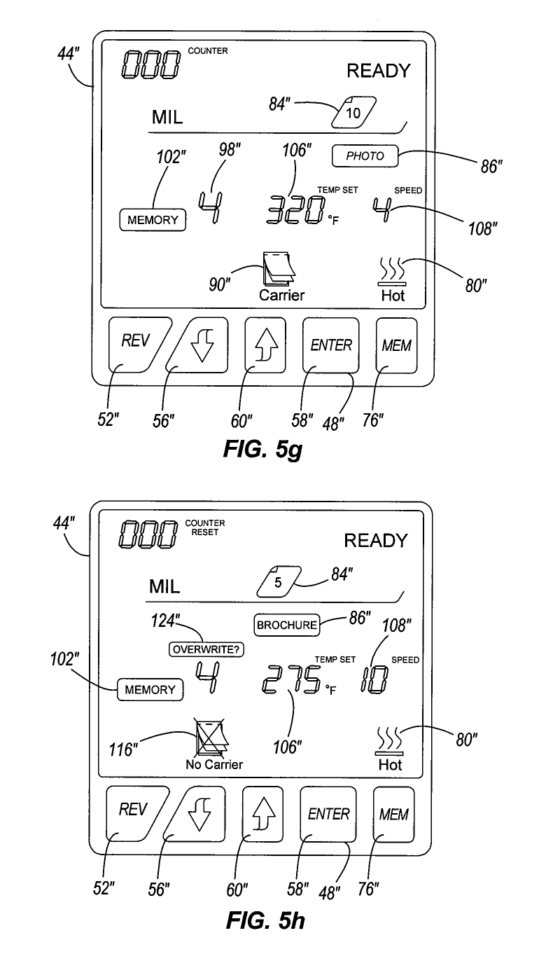

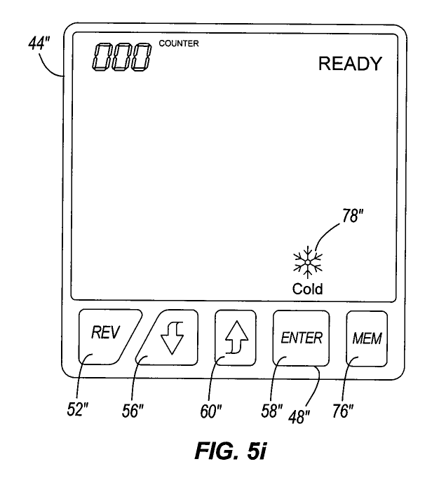

FIGS. 5a-5i illustrate another alternative construction of the display 44 and the user controls 48 of the laminator 30 of FIGS. 1-3m. The display 44″ and the user controls 48″ illustrated in FIGS. 5a-5h and the method of operation are substantially the same as the display 44, the controls 48, and the method of operation discussed above with regard to the laminator 30 of FIGS. 1-3m (as well as the display 44′ and the controls 48′ of FIGS. 4a-4h) and therefore like components have been give like reference numbers plus a double prime symbol and only the general differences will be discussed below.

FIG. 5a illustrates the display 44″ with all the indicators of the display lighted or in an ‘on’ configuration. The display 44″ further includes a ‘no carrier’ indicia 116″, a ‘manual’ indicia 120″, and an ‘overwrite’ indicia 124″, but does not include a ‘preset’ indicia.

The illustrated display 44″ and user controls 48″ allow a user to select between four modes: a ‘menu’ mode (FIGS. 5b and 5c), a ‘manual’ mode (FIGS. 5d and 5e), a ‘memory’ mode (FIGS. 5f-5h), and a ‘cold’ mode (FIG. 5i). The user may cycle through the modes using the ‘up’ button 60″ and the ‘down’ button 56″ and may select one of the modes using the ‘enter’ button 58″. In the illustrated embodiment, the thickness listing 84″, the paper listing 86″, the ‘carrier’ indicia 90″, and the ‘no carrier’ indicia 116″ blink, or flash, when the user cycles to the ‘menu’ mode; the ‘manual’ indicia 120″, the temperature set point display 106″, and the speed set point display 108″ blink when the user cycles to the ‘manual’ mode; the ‘memory’ indicia 102″ blinks when the user cycles to the ‘memory’ mode; and the ‘cold’ indicia 78″ blinks when the user cycles to the ‘cold’ mode.

Referring to FIG. 5b, after selecting the ‘menu’ mode, the user selects the thickness of the pouch that will be utilized using the thickness listing 84″, the paper type or media that will be laminated using the paper listing 86″, and whether a carrier is utilized using the ‘carrier’ and ‘no carrier’ indicia 90″, 116″. The microprocessor of the laminator then determines the appropriate temperature set point and speed set point and displays them at the temperature set point display 106″ and the speed set point display 108″, respectively. FIG. 5c illustrates the display 44″ after a thickness of 5 mils, a paper type of ‘brochure’, and ‘no carrier’ have been selected.

In the illustrated embodiment, whenever a thickness of 1.5 mils is selected, the microprocessor of the laminator 30 automatically selects that a carrier is being utilized, regardless of the paper type selected. In addition, whenever a thickness of ‘board’ is selected, the laminator 30 automatically begins to warm up without having the user select a paper type or whether a carrier is utilized.

In some embodiments, after the temperature set point and speed set point are displayed, the user may manually adjust the temperature set point and the speed set point by pressing the ‘enter’ button 58″. The temperature set point and the speed set point may then be increased or decreased using the ‘up’ button 60″ and the ‘down’ button 56″, respectively. Such an arrangement may be desirable if the user knows, for example, that a particular type or brand of laminate functions better under different operating conditions than those provided.

Referring to FIG. 5d, after selecting the ‘manual’ mode, the user adjusts the temperature set point and the speed set point to desired values. FIG. 5e illustrates the display 44″ after a temperature set point of 320° F. and a speed set point of #15 have been selected.

Referring to FIG. 5f, after selecting the ‘memory’ mode, the preset number 98″ blinks such that the user may cycle through the list of saved or preset operating modes. In the illustrated embodiment, the user may cycle through five preset numbers 98″. In other embodiments, the user may cycle through fewer or more preset numbers 98″. For example, as shown in FIG. 5g, the preset number #4 corresponds to a thickness of 10 mils, a paper type of ‘photo’, and a carrier. Accordingly, the temperature set point is 320° F. and the speed set point is #4.

In the illustrated embodiment, the user may save or store any of the operating conditions generated by the ‘menu’ mode or the ‘manual’ mode. Once the temperature set point and the speed set point are determined and the time to ready display 112″ is counting down or ‘READY’, the user may hold down the ‘MEM’ button 54″ (e.g., for approximately three seconds) to save the operating condition as one of the preset numbers 98″. If the preset number 98″ is already associated with an operating condition, the ‘overwrite’ indicia 124″ will become visible (as shown in FIG. 5h). The user may then select to overwrite this preset number 98″ or assign the operating condition to a different preset number 98″.

In some embodiments, pressing the ‘MEM’ button 54″ during any operating mode will change the display 44″ to the ‘memory’ mode. In such embodiments, the user may press the ‘MEM’ button 54″ again or wait approximately five seconds to return the display 44″ to the previous mode.

Referring to FIG. 5i, the ‘cold’ mode is selected such that the laminator 30 is configured for cold lamination.

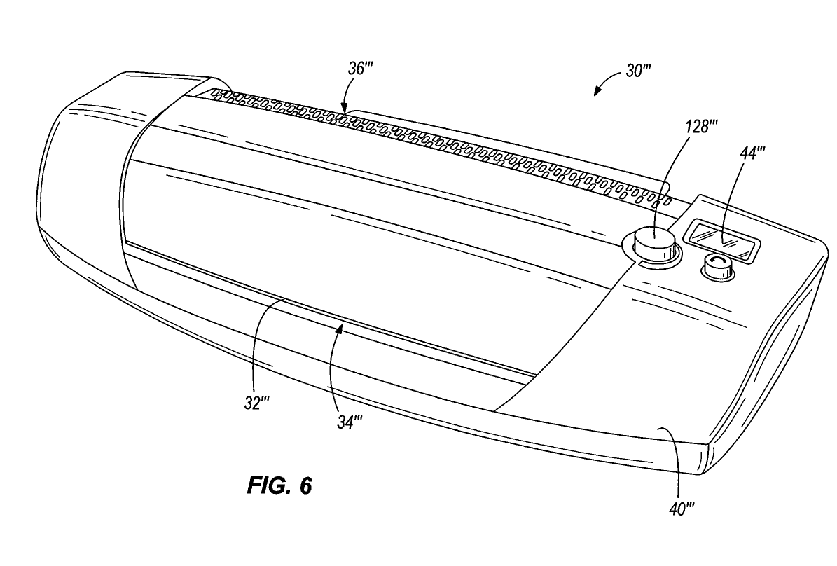

FIG. 6 illustrates an alternative construction of the laminator 30 of FIGS. 1-3m. The laminator 30′″ of FIG. 6 is substantially the same as the laminator 30 of FIGS. 1-3m and like components have been given like reference numbers plus a triple prime symbol and only the general differences will be discussed below.

Instead of including multiple push buttons, the laminator 30′″ includes a dial or rotatable selector 128′″ that is utilized by the user to select from settings, 1-10 in the illustrated construction, that correspond to a temperature set point (i.e., a fixed speed laminator), a speed set point (i.e., a fixed temperature laminator), or a combination speed and temperature set point. After the user selects the desired setting using the selector 128′″, the display 44′″ displays the time to ready or approximate time until the actual temperature of the rollers of the laminator 30′″ reaches the set point temperature that corresponds to the setting 1-10 selected by the user. The laminator 30′″ determines the time to ready utilizing the microprocessor and temperature sensing element as discussed above with regard to the laminator 30 of FIGS. 1-3m.

In yet other embodiments, the laminator can be a fixed temperature and a fixed speed laminator. In such a laminator, the user input or input variable includes the user turning ‘on’ the laminator, such as by supplying power to the laminator. Then, as discussed above, a microprocessor and a display of the laminator can be utilized to determine and display the ‘time to ready.’

Various features and advantages of the invention are set forth in the following claims.

What is claimed is:

1. A method of operating a laminator, the method comprising:
inputting a variable that corresponds to a set point temperature of a roller of the laminator;
determining an actual temperature of the roller of the laminator; and
estimating a time until the actual temperature of the roller approximately equals the set point temperature of the roller.

2. The method of operating the laminator of claim 1, further comprising displaying the time using a display of the laminator.

3. The method of operating the laminator of claim 1, wherein inputting a variable includes,
inputting a variable that corresponds to a thickness of a film utilized by the laminator;
inputting a variable that corresponds to a type media to be laminated with the film; and
inputting a variable that corresponds to whether a carrier is utilized with the laminator.

4. The method of operating the laminator of claim 3, wherein inputting a variable that corresponds to a thickness of a film includes selecting the thickness of the film from a thickness list, and wherein inputting a variable that corresponds to a type of media to be laminated includes selecting the media from a media list.

5. The method of operating the laminator of claim 1, wherein estimating a time until the actual temperature of the roller approximately equals the set point temperature of the roller includes utilizing a look-up table stored by a microprocessor of the laminator.

6. The method of operating the laminator of claim 5, further comprising:
after estimating a time, re-estimating a time until the actual temperature of the roller approximately equals the set point temperature of the roller to provide an updated time; and
displaying the updated time.

7. A method of operating a laminator, the method comprising:
inputting a set point temperature of a roller of the laminator;
determining an actual temperature of the roller;
estimating a time until the actual temperature of the roller approximately equals the set point temperature of the roller using a look-up table stored by a microprocessor of the laminator; and
displaying the time.

8. The method of operating the laminator of claim 7, further comprising:
after estimating a time, re-estimating a time until the actual temperature of the roller approximately equals the set point temperature of the roller to provide an updated time; and
displaying the updated time.

9. A laminator comprising:
a housing;
a roller located within the housing;
an input device operable to receive an input from a user;
a processor operable to determine a set point temperature based on the input received by the input device; and
a temperature sensing element operable to determine an actual temperature of the roller,
wherein the processor is operable to estimate a time until the actual temperature of the roller approximately equals the set point temperature.

10. The laminator of claim 9, wherein the input device is a button.

11. The laminator of claim 9, wherein the input device is a dial.

12. The laminator of claim 9, further comprising a screen for displaying indicia corresponding to the input from the user.

13. The laminator of claim 9, further comprising a screen for displaying the time until the actual temperature of the roller approximately equals the set point temperature.

14. The laminator of claim 9, further comprising a look-up table stored by the processor, the look-up table including data that enables the processor to estimate the time until the actual temperature of the roller approximately equals the set point temperature.

15. The laminator of claim 9, further comprising an indicator operable to indicate that the actual temperature of the roller approximately equals the set point temperature.

16. A method of operating a laminator including a display and a roller, the method comprising:
displaying a plurality of indicia on the display of the laminator;
selecting at least one of the plurality of indicia; and
determining a set point temperature of the roller of the laminator based on the at least one of the plurality of indicia selected.

17. The method of claim 16, further comprising displaying the set point temperature on the display.

18. The method of claim 16, further comprising determining a set point speed of laminator based on the at least one of the plurality of indicia selected.

19. The method of claim 18, further comprising displaying the set point temperature and the set point speed on the display.

20. The method of claim 16, wherein the plurality of indicia represents at least one of a thickness of a film utilized by the laminator, a type of media to be laminated with the film, and whether a carrier is utilized with the laminator.

21. The method of claim 16, wherein selecting at least one of the plurality of indicia includes selecting a first indicia, selecting a second indicia, and selecting a third indicia.

22. The method of claim 21, wherein the first indicia represents a thickness of a film utilized by the laminator, the second indicia represents a type of media to be laminated with the film, and the third indicia represents whether a carrier is utilized with the laminator.

23. The method of claim 16, further comprising saving the at least one of the plurality of indicia selected and the set point temperature in a memory of the laminator.
